(19) United States
(12) Patent Application Publication
(10) Pub. No.: US 2026/0238291 A1
(43) Pub. Date: Aug. 13, 2026

(54) CHANNEL STATE INFORMATION REPORTING

(71) Applicant: ZTE CORPORATION, Shenzhen, Guangdong (CN)

(72) Inventors: Minqiang ZOU, Shenzhen (CN); Bo GAO, Shenzhen (CN); Guangyu JIANG, Shenzhen (CN); Ke YAO, Shenzhen (CN); Wenjun YAN, Shenzhen (CN)

(21) Appl. No.: 19/471,038

(22) PCT Filed: Apr. 7, 2023
(86) PCT No.: PCT/CN2023/087147

§ 371 Date: Sep. 30, 2025

(51) Int. Cl. H04B 7/06

(52) U.S. Cl. CPC H04B 7/0626; H04B 7/0639

(57) ABSTRACT

A method for wireless communication, including: receiving, by a terminal device associated with a mobility event, one or more reference signals; determining, by the terminal device, information related to channel state information (CSI) based on the one or more reference signals, where the information includes at least a processing criterion or a computation time; and transmitting, by the terminal device, a CSI report to a base station based on the one or more reference signals and the information about the CSI.

### CROSS-REFERENCE TO RELATED APPLICATION(S)

This application is a national phase entry under 35 USC 371 of International Patent Application No. PCT/CN2023/087147 filed on Apr. 7, 2023, and the entire content of the International Patent Application is incorporated into this application by reference.

### TECHNICAL FIELD

This patent document is directed to digital communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

In one example aspect, a method for wireless communication includes receiving, by a terminal device associated with a mobility event, one or more reference signals, and determining, by the terminal device, information related to channel state information (CSI) based on the one or more reference signals. The information comprises at least a processing criterion or a computation time. The method also includes transmitting, by the terminal device, a CSI report to a base station based on the one or more reference signals and the information about the CSI.

In another example aspect, a method for wireless communication includes transmitting, by a base station to a terminal device associated with a mobility event, one or more reference signals and receiving, by the base station, a channel state information (CSI) report that is determined based on the one or more reference signals and information about the CSI. The information comprises at least a processing criterion or a computation time. The method also includes performing a subsequent communication with the terminal device based on the CSI report.

In another example aspect, a communication apparatus is disclosed. The apparatus includes a processor that is configured to implement an above-described method.

In yet another example aspect, a computer-program storage medium is disclosed. The computer-program storage medium includes code stored thereon. The code, when executed by a processor, causes the processor to implement a described method.

These, and other, aspects are described in the present document.

### BRIEF DESCRIPTION OF DRAWINGS

FIG. 1 illustrates a schematic diagram of an example multiple-input and multiple-output (MIMO) configuration.

FIG. 2A is a flow chart representation of a method for wireless communication in accordance with one or more embodiments of the present technology.

FIG. 2B is a flow chart representation of another method for wireless communication in accordance with one or more embodiments of the present technology.

FIG. 3 illustrates a diagram of example computational delays of the Channel State Information (CSI) reporting in accordance with one or more embodiments of the present technology.

FIG. 4 illustrates an example non-zero coefficients with respect to a strong coefficient in a precoder matrix in accordance with one or more embodiments of the present technology.

FIG. 5 shows an example of a wireless communication system where techniques in accordance with one or more embodiments of the present technology can be applied.

FIG. 6 is a block diagram representation of a portion of a radio station in accordance with one or more embodiments of the present technology can be applied.

### DETAILED DESCRIPTION

Section headings are used in the present document only to improve readability and do not limit scope of the disclosed embodiments and techniques in each section to only that section. Furthermore, some embodiments are described with reference to Third Generation Partnership Project (3GPP) Fifth Generation (5G) New Radio (NR) or Sixth Generation (6G) standard for ease of understanding and the described technology may be implemented in different wireless system that implement protocols other than the NR or 6G protocol.

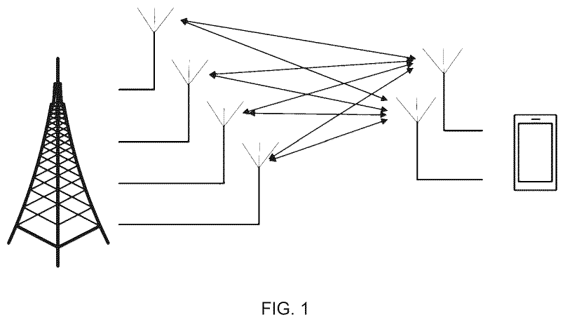

In radio communications, multiple-input and multiple-output (MIMO) is a method for multiplying the capacity of a radio link using multiple transmission and receiving antennas to exploit multipath propagation. FIG. 1 illustrates a schematic diagram of an example MIMO configuration. In this example, the base station has four transmission and receiving antennas whereas the user equipment (UE) has two transmission and receiving antennas.

MIMO is one of the key technologies in NR systems and is successful in commercial deployment. In Release 15/16/17 of the 3GPP standard, MIMO features were investigated and specified for both Frequency Division Duplex (FDD) and Time Division Duplex (TDD) systems. However, significant loss of performance for a User Equipment UE that moves at a high/medium speed has been observed in commercial deployments, especially in multi-user MIMO (MU-MIMO) scenarios. Further investigations revealed that the performance loss is partly caused by outdated Channel State Information (CSI). Therefore, there remains a need to introduce enhancements on CSI measurement and report to alleviate such loss in Release 18 of the 3GPP standard.

This patent discloses techniques that can be implemented to provide new designs of CSI reporting so as to reduce loss of performance of UEs, particularly ones that are associated with mobility events at a medium/high speed. The disclosed techniques comprise different aspects of CSI measurements and reporting, such as the indication associated with a strongest coefficient in the precoder, the inclusion of Doppler domain vectors in the determination of priority, the computation delay(s) associated with CSI reporting, alternative ways of determining the number of CSI processing units, etc. Techniques in one or more these aspects can be combined to achieve more effective CSI measurements and reporting, thereby improving transmission efficiency for the UEs.

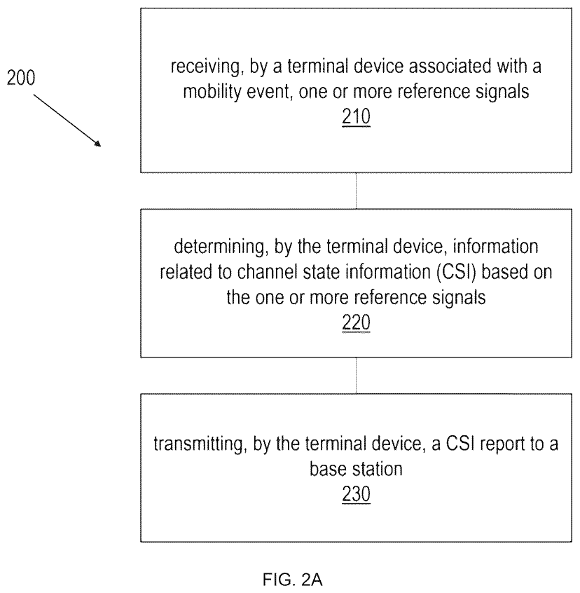

FIG. 2A is a flow chart representation of a method 200 for wireless communication in accordance with one or more embodiments of the present technology. The method 200 includes, at operation 210, receiving, by a terminal device associated with a mobility event, one or more reference signals. The method 200 includes, at operation 220, determining, by the terminal device, information related to channel state information (CSI) based on the one or more reference signals. The information comprises at least a processing criterion or a computation time. The method also includes, at operation 230, transmitting, by the terminal device, a CSI report to a base station based on the one or more reference signals and the information about the CSI.

FIG. 2B is a flow chart representation of a method 250 for wireless communication in accordance with one or more embodiments of the present technology. The method 250 includes, at operation 260, transmitting, by a base station to a terminal device associated with a mobility event, one or more reference signals. The method 250 includes, at operation 270, receiving, by the base station, a channel state information (CSI) report that is determined based on the one or more reference signals and information related to the CSI. The information comprises at least a processing criterion or a computation time. The method 250 includes, at operation 280, performing a subsequent communication with the terminal device based on the CSI report.

In some embodiments, the CSI report comprises a parameter indicating a location of a strongest coefficient for each layer of a precoder. In some embodiments, the parameter occupies X bits, where X is associated with a value K^{NZ} that represents a number of non-zero coefficients in the precoder. In some embodiments, the CSI report identifies a precoder that is associated with a first type of vectors, a second type of vectors, and a third type of vectors. X is equal to ceil (log (2, min (K^{NZ}, 2L))) or ceil (log (2, min (K^{NZ}, 2LQ))), where L represents a number of the first type of vectors in the precoder and Q represents a number of the third type of vectors in the precoder. In some embodiments, the CSI report identifies a precoder that is associated with a first type of vectors, a second type of vectors, and a third type of vectors, and the parameter occupies Y bits. Y is associated with a value L that represents a number of the first type of vectors in the precoder. In some embodiments, Y is equal to ceil (log (2, 2L)) or ceil (log (2, 2LQ)), where L represents a number of the first type of vectors in the precoder and Q represents a number of a third type of vectors in the precoder.

In some embodiments, non-zero coefficients are indicated based on parameter that indicates a distance between the non-zero coefficients and the strongest coefficient. In some embodiments, the parameter is configured by the base station, and a value of the parameter is determined based on a number of a second type of vectors in the precoder.

In some embodiments, the CSI report identifies a precoder that is associated with a first type of vectors, a second type of vectors, and a third type of vectors. For each reported element in the CSI report, a priority is associated with the reported element based on an index of a vector of the third type. In some embodiments, the priority is based on a number of the third type of vectors. In some embodiments, the priority is based on a number of the second type of vectors. In some embodiments, the priority is determined based on 2·L·ν·Q·F(f)+2·L·ν·G(q)+ν·i+l, wherein L represents a number of the first type of vectors, ν represents a number of ranks in the precoder, Q represents a number of the third type of vectors, f represents an index of a second type vector, F(f) represents a function with respect to f, q represents an index of a third type vector, and G(q) represents a function with respect to q. In some embodiments, the priority is determined based on 2·L·ν·M·G(q)+2·L·ν·F(f)+ν·i+l, wherein L represents a number of the first type of vectors, ν represents a number of ranks in the precoder, M represents a number of the second type of vectors, q represents an index of a third type vector, G(q) represents a function with respect to q, f represents an index of a second type vector, F(f) represents a function with respect to f.

In some embodiments, the processing criterion is based on a number of CSI processing units used to determine the CSI report, and the number of CSI processing units is based on a constant that is greater than or equal to 1 or a capability of the terminal device. In some embodiments, the number of CSI processing units is based on a periodic of a CSI reference signal resource. In some embodiments, the CSI report identifies a precoder that is associated with a first type of vectors, a second type of vectors, and a third type of vectors, and the number of CSI processing units is based on a length of a vector of the third type. In some embodiments, the number of CSI processing units used to determine the CSI report is based on one or more resources for the one or more reference signals. In some embodiments, the number of CSI processing units is based on a number of CSI reference signal (RS) resources. In some embodiments, the number of CSI processing units is based on an offset between two CSI RS resources.

In some embodiments, the computation time is based on at least a first computation delay or a second computation delay. The method includes adapting at least one of the first computation delay or the second computation delay for transmitting the CSI report such that at least one of the first computation delay or the second computation delay comprises additional symbols. In some embodiments, the first computation delay and/or the second computation delay are based on a constant or a capability of the terminal device. In some embodiments, the first computation delay and/or the second computation delay are based on a periodicity of CSI RS resource. In some embodiments, the CSI report identifies a precoder that is associated with a first type of vectors, a second type of vectors, and a third type of vectors, and the first computation delay and/or the second computation delay are based on a length of a vector of the third type. In some embodiments, the first computation delay and the second computation delay are based on an offset between two CSI RS resources. In some embodiments, the first computation delay and/or the second computation delay are based on a number of CSI RS resources.

In some embodiments, a number of CSI processing units and at least one of a first computation delay or a second computation delay are determined based on a signaling message from the base station. In some embodiments, the signaling message comprises a Radio Resource Control message.

The above aspects are further discussed in the embodiments below.

### Embodiment 1: Indicator for the Strongest Coefficient

Currently, the precoding matrices indicated by the precoding matrix indicator (PM) are determined from L+Mv vectors, where L vectors are considered as a first type of vectors (e.g., spatial domain Discrete Fourier Transform (DFT) base vectors) and Mv vectors are considered as a second type of vectors (e.g., frequency domain DFT base vectors). For example, L antenna ports per polarization are selected by the index i_{1,1} where

$${i}_{1 , 1} ∈ \{ 0 , 1 , … , ⌈ \frac{{P}_{CSI - RS}}{2 d} ⌉ - 1 \} .$$

In some cases, the index of the strongest coefficient is 0 after remapping.

In Rel-18, a new Type II codebook can be introduced to provide suitable CSI, e.g., for UEs that move at high/medium velocities. A third type of vectors (e.g., Doppler domain DFT base vectors) can be used in the precoder. Furthermore, a parameter can be configured to indicate the location/index of the strongest coefficient on each layer in the precoder matrix.

When the rank indicator indicates that the rank is equal to 1, there are several ways to represent such a parameter:
Alt 1-1: The parameter occupies ceil (log (2, 2L)) bits, where L represents the number of the first type of vectors in the precoder.
Alt 1-2: The parameter occupies ceil (log (2, min (K^{NZ}, 2L))) bits, where L represents the number of the first type of vectors in the precoder and K^{NZ} represents the number of non-zero coefficients in the precoder.
Alt 1-3: The parameter occupies ceil (log (2, 2LQ)) bits, wherein L represents the number of the first type of vectors in the precoder and Q represents the number of the third type of vectors in the precoder.
Alt 1-4: The parameter occupies ceil (log (2, min (K^{NZ}, 2LQ))) bits, where K^{NZ} represents the number of non-zero coefficients in the precoder, L represents the number of the first type of vectors in the precoder, and Q represents the number of the third type of vectors in the precoder.

When the rank indicator indicates that the rank is greater than 1, there are several alternative ways to represent the parameter:
Alt 1-5: The parameter occupies ceil (log (2, min (K^{NZ}, 2L))) bits, where L represents the number of the first type of vectors in the precoder, and K^{NZ} represents the number of non-zero coefficients in the precoder.
Alt 1-6: The parameter occupies ceil (log (2, 2LQ)) bits, where L represents the number of the first type of vectors in the precoder, and Q represents the third type of vectors in the precoder.
Alt 1-7: The parameter occupies ceil (log (2, min (K^{NZ}, 2LQ))) bits, where K^{NZ} represents the number of non-zero coefficients in the precoder, L represents the number of the first type of vectors in the precoder, and Q represents the number of the third type of vectors in the precoder.

In some embodiments, the number of the third type of the vectors (e.g., Doppler domain DFT base vectors) can be configured as a fixed value (e.g., Q=2) regardless of the rank value.

In some embodiments, if the report CSI is associated with a CSI-RS resource set, which include N CSI-RS resources for CSI channel measurement, the value of L can be determined as

$$L = {\sum }_{n = 0}^{N - 1} {L}_{n} ,$$

where Ln represents the number of the first type of vectors associated with the n-th CSI-RS resource in the precoder.

### Embodiment 2: Priority Values for Reported Elements

For a given CSI report, each reported element of certain indices is associated with a priority value. In Release 18, a new priority formular can be introduced to account for the third type of vectors (e.g., Doppler domain DFT base vectors). Several options can be considered:
Option 2-1: The priority value is represented as Pri(l, i, f, q)=2·L·ν·Q·F(f)+2·L·ν·G(q)+ν·i+l.
Option 2-2: The priority value is represented as Pri(l, i, f, q)=2·L·ν·M·G(q)+2·L·ν·F(f)+ν·i+l.

In both options above, L represents the first type of vectors in the precoder per polarization, ν represents the number of rank in the precoder, l is the index of the rank where l=0, 1, 2, . . . , ν-1, M represents the number of the second type of vectors in the precoder, Q represents the number of the third type of vectors in the precoder, i is the index of a first type vector across two polarization where i=0, 1, 2, . . . , 2L-1, f is the index of a second type vector where f=0, 1, 2, . . . , M-1, and q is the index of a third type vector q=0, 1, 2, . . . , Q-1.

### Embodiment 3: CSI Processing Units (CPUs)

When a UE supports N_{CPU} simultaneous CSI calculations, the UE is considered to have N_{CPU} CSI processing units for processing CSI reports. If L CPUs are occupied for calculation of CSI reports in a given OFDM symbol, the UE has N_{CPU}-L unoccupied CPUs. If N CSI reports start occupying their respective CPUs on the same OFDM symbol on which N_{CPU}-N CPUs are unoccupied, where each CSI report n=0, . . . , N-1 corresponds to

$${O}_{CPU}^{( n )} .$$

In Release 18, the determination of O_{CPU} can be based on a constant that is associated with the available CSI processing units or the UE capability.

For periodic or semi-persistent CSI Reference Signal configurations, the following cases can be considered:
Case 3-1: O_{CPU} is determined based on a variable X.
Case 3-2: O_{CPU} is equal to the variable X.
Case 3-3: O_{CPU} is determined based on a variable X and a variable P, where P is equal to the periodicity of the CSI-RS resource.
Case 3-4: O_{CPU} is determined based on a variable X and a variable N, where N is the length of a third type vector (e.g., a Doppler domain DFT vector).
Case 3-5: O_{CPU} is determined by a variable X, a variable N, and a variable P, where P is equal to the periodicity of the CSI-RS resource and N is the length of a third type vector.

For aperiodic CSI Reference Signal configurations, the following cases can be considered:
Case 3-6: O_{CPU} is determined based on a variable K, wherein K is the number of CSI-RS resources in the CSI-RS resource set for channel measurement. For example, O_{CPU}=K/2.
Case 3-7: O_{CPU} is determined by a variable m, where m is the offset between two CSI-RS resources. For example, O_{CPU} can be inverse proportional to the value of m, such as O_{CPU}=4 when m=1, O_{CPU}=2 when m=2, etc.
Case 3-8: O_{CPU} is determined based on a variable K and a variable X, where K is the number of CSI-RS resources in the CSI-RS resource set for channel measurement. For example, O_{CPU}=ceil (K/4)×λ.
Case 3-9: O_{CPU} is determined based on a variable m and a variable X, where m is the offset between two CSI-RS resources. For example, O_{CPU} can be positive proportional to the value of m and is proportional to the value of X, such as O_{CPU}=mX.
Case 3-10: O_{CPU} is determined by a variable m and a variable K, where m is the offset between two CSI-RS resources and K is the number of CSI-RS resources in the CSI-RS resource set for channel measurement. For example, O_{CPU} can be inverse proportional to the value of m but is proportional to the value of K, such as O_{CPU}=K/m.
Case 3-11: O_{CPU} is determined by a variable m, a variable K, and a variable X, where m is the offset between two CSI-RS resources and K is the number of CSI-RS resources in the CSI-RS resource set for channel measurement. For example, O_{CPU}=ceil (K/4m)*X.

In the above cases, the variable X is a constant associated with the available CSI processing units (e.g., X=1, 2, . . . , etc.). Alternatively, or in addition, X is based on the UE capability.

### Embodiment 4: Computational Delays

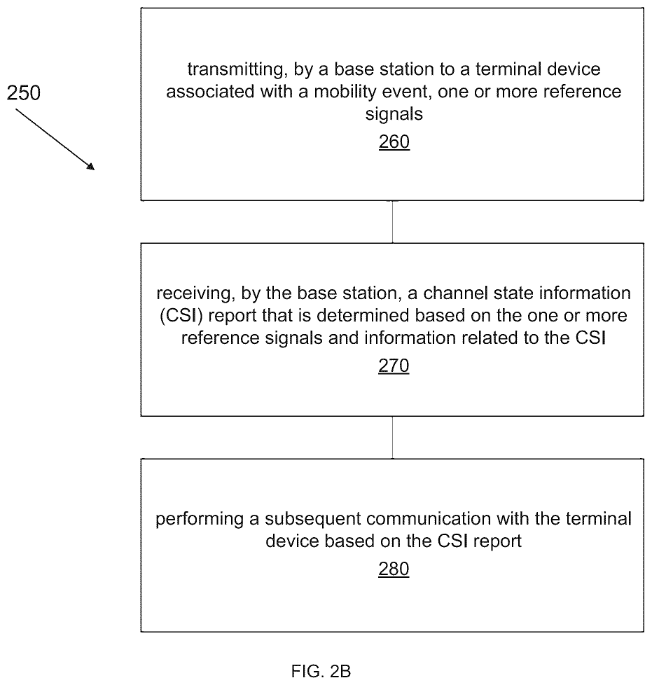

Currently, in order to ensure that the UE has enough time to decode Downlink Control Information and process CSI, the time slot and Orthogonal Frequency-Division Multiplexing (OFDM) symbol position of CSI feedback need to meet the following two conditions at the same time. FIG. 3 illustrates a diagram of example computational delays of the CSI reporting in accordance with one or more embodiments of the present technology.

Condition 1: From the last OFDM symbol of the Physical Downlink Control Channel (PDCCH) containing the DCI that triggers the CSI (301) to the first OFDM symbol of the Physical Uplink Shared Channel (PUSCH) that carries the CSI (302), there is an interval of at least Z OFDM symbols.

Condition 2: From the last OFDM symbol of the CSI-RS and CSI Interference Measurement (IM) for calculating CSI (303) to the first OFDM symbol of the PUSCH carrying the CSI (302), there must be at least Z′ OFDM symbols.

Variables Z and Z′ can be defined as

$$Z = {max}_{m = 0 , … , M - 1} ( Z ( m ) ) and {Z}^{′} = {max}_{m = 0 , … , M - 1} ( {Z}^{′} ( m ) ) ,$$

where M is the number of updated CSI report(s). The values of Z and Z′ are specified in the 3GPP standard in Table 1 and Table 2 below.

TABLE 1
CSI computation delay requirement 1

Z₁ [symbols]

| μ | Z₁ | Z′₁ |
|---|---|---|
| 0 | 10 | 8 |
| 1 | 13 | 11 |
| 2 | 25 | 21 |
| 3 | 43 | 36 |

TABLE 2
CSI computation delay requirement 2

| | Z₁ [symbols] | | Z₂ [symbols] | | Z₃ [symbols] | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₀ |
| 1 | 33 | 30 | 72 | 69 | 33 | X₁ |
| 2 | 44 | 42 | 141 | 140 | min(44, X₂ + KB₁) | X₂ |
| 3 | 97 | 85 | 152 | 140 | min(97, X₃ + KB₂) | X₃ |
| 5 | 388 | 340 | 608 | 560 | min(388, X₅ + KB₃)) | X₅ |
| 6 | 776 | 680 | 1216 | 1120 | min(776, X₆ + KB₄)) | X₆ |

To reduce performance loss of the UEs, particularly for the ones that are associated with mobility events and/or move at a medium/high speed, the number of OFDM symbols indicated by Z and Z′ need to be increased and/or be adapted.

For periodic or semi-persistent CSI Reference Signal configurations, the following cases can be considered:
Case 4-1: Z and/or Z′ are determined by a variable Y.
Case 4-2: Z and/or Z′ are determined by a variable Y and a variable P, where P is equal to the periodicity of the CSI-RS resource.
Case 4-3: Z and/or Z′ are determined by a variable Y and a variable N, where N is the length of a third type vector (e.g., a Doppler domain DFT vector).
Case 4-4: Z and/or Z′ are determined by a variable Y, a variable N and a variable P, where P is equal to the periodicity of the CSI-RS resource and N is the length of a third type vector.

For aperiodic CSI Reference Signal configurations, the following cases can be considered:
Case 4-5: Z and/or Z′ are determined by a variable Y.
Case 4-6: Z and/or Z′ are determined by a variable m, a variable K and a variable Y, where m is the offset between two CSI-RS resources and K is the number of CSI-RS resources in the CSI-RS resource set for channel measurement.
Case 4-7: Z and/or Z′ are determined by a variable m, a variable K, a variable N and a variable Y, where m is the offset between two CSI-RS resources, K is the number of CSI-RS resources in the CSI-RS resource set for channel measurement, and N is the length of a third type vector (e.g., a Doppler domain DFT vector).

In the above cases, the variable Y can be a constant value that is associated with the number of symbols. For example, depending on the requirement (requirement 1 or requirement 2) and the subcarrier spacing μ, Y can be 5 symbols, 10 symbols, or be in the range of tens or hundreds of symbols. Alternatively, or in addition, Y is based on the UE capability.

In some embodiments, the determination of the CPUs (O_{CPU}) and the Z/Z′ values is based on an indication from the base station, such as a higher layer signaling message (e.g., Radio Resource Control signaling). In some embodiments, the indication indicates a determination or transmission mode that is used to determine the O_{CPU} and Z/Z′ values. For example, in mode 1, O_{CPU} can be determined according to the techniques described in Embodiment 3, while the Z and/or Z′ values remain unchanged as specified in Table 1 and Table 2. As another example, in mode 2, O_{CPU} can be determined using conventional methods (e.g., according to Release 16 of the 3GPP standard) while Z/Z′ values are adapted to account for more OFDM symbols in the delay(s). As yet another example, O_{CPU} can be determined according to the techniques described in Embodiments 3 and Z/Z′ values are adapted to account for more OFDM symbols in the delay(s) (e.g., as discussed in Embodiment 4).

### Embodiment 5: Indication of the Non-Zero Coefficients

Referring back to Embodiment 1, given that the location of the strongest coefficient in the precoder is indicated, other non-zero coefficients can be indicated/determined based on the relative positions/distances with respect to the strongest coefficient.

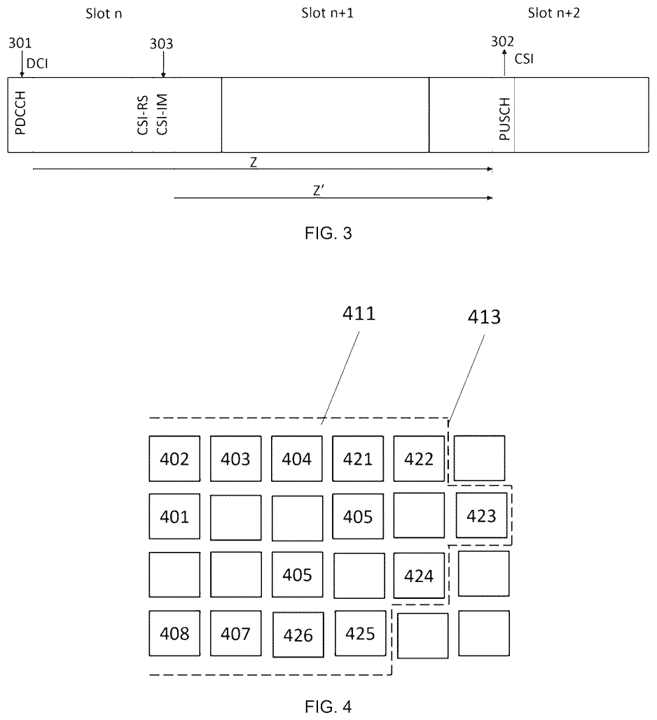

FIG. 4 illustrates an example non-zero coefficients with respect to a strong coefficient in a precoder matrix in accordance with one or more embodiments of the present technology. In FIG. 4, coefficient 401 is the strongest coefficient. A parameter d indicating a maximal distance from the non-zero coefficients to the strongest coefficients can be configured by the base station. The UE can determine which non-zero coefficients need to be reported given the configured parameter d.

For example, if d=3, non-zero coefficients that are within a distance of 3 should be reported. In the specific example shown in FIG. 4, non-zero elements within the light dotted line 411, such as 402, 403, . . . , 407, 408, are reported by the UE. If d=5, non-zero coefficients that are within a distance of 5 should be reported. In the specific example shown in FIG. 4, non-zero elements within the dark dotted line 413, such as 402, 403, 404, 421, 422, 423, 424, 425, . . . , 407, 408, are reported by the UE.

In some embodiments, the parameter d is determined by M, where M represents the number of the second type of vectors in the precoder (e.g., Frequency Domain base vectors). The value of d can be determined based on at least one of the following alternatives:

$$Alt 1 : d = ceil ( M / 2 )$$

$$Alt 2 : d = floor ( M / 2 )$$

$$Alt 3 : d <= ceil ( M / 2 )$$

$$Alt 4 : d <= floor ( M / 2 )$$

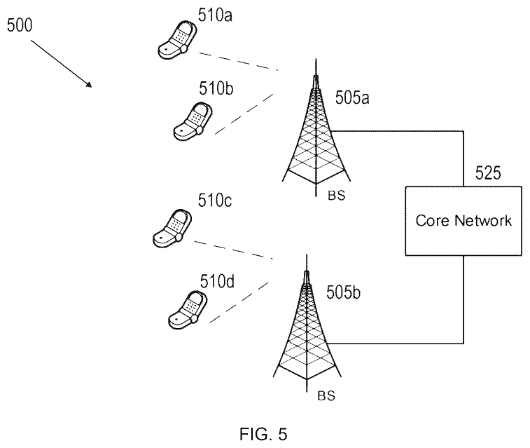

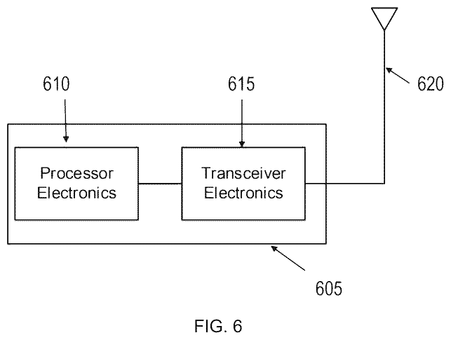

FIG. 5 shows an example of a wireless communication system 500 where techniques in accordance with one or more embodiments of the present technology can be applied. A wireless communication system 500 can include one or more base stations (BSs) 505a, 505b, one or more wireless devices (or UEs) 510a, 510b, 510c, 510d, and a core network 525. A base station 505a, 505b can provide wireless service to user devices 510a, 510b, 510c and 510d in one or more wireless sectors. In some implementations, a base station 505a, 505b includes directional antennas to produce two or more directional beams to provide wireless coverage in different sectors. The core network 525 can communicate with one or more base stations 505a, 505b. The core network 525 provides connectivity with other wireless communication systems and wired communication systems. The core network may include one or more service subscription databases to store information related to the subscribed user devices 510a, 510b, 510c, and 510d. A first base station 505a can provide wireless service based on a first radio access technology, whereas a second base station 505b can provide wireless service based on a second radio access technology. The base stations 505a and 505b may be co-located or may be separately installed in the field according to the deployment scenario. The user devices 510a, 510b, 510c, and 510d can support multiple different radio access technologies. The techniques and embodiments described in the present document may be implemented by the base stations of wireless devices described in the present document.

FIG. 5 is a block diagram representation of a portion of a radio station in accordance with one or more embodiments of the present technology can be applied. A radio station 605 such as a network node, a base station, or a wireless device (or a user device, UE) can include processor electronics 610 such as a microprocessor that implements one or more of the wireless techniques presented in this document. The radio station 605 can include transceiver electronics 615 to send and/or receive wireless signals over one or more communication interfaces such as antenna 620. The radio station 605 can include other communication interfaces for transmitting and receiving data. Radio station 605 can include one or more memories (not explicitly shown) configured to store information such as data and/or instructions. In some implementations, the processor electronics 610 can include at least a portion of the transceiver electronics 615. In some embodiments, at least some of the disclosed techniques, modules or functions are implemented using the radio station 605. In some embodiments, the radio station 605 may be configured to perform the methods described herein.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method for wireless communication, comprising:
receiving, by a terminal device associated with a mobility event, one or more reference signals;
determining, by the terminal device, information related to channel state information (CSI) based on the one or more reference signals, wherein the information comprises at least a processing criterion or a computation time; and
transmitting, by the terminal device, a CSI report to a base station based on the one or more reference signals and the information about the CSI.

2. A method for wireless communication, comprising:
transmitting, by a base station to a terminal device associated with a mobility event, one or more reference signals;
receiving, by the base station, a channel state information (CSI) report that is determined based on the one or more reference signals and information related to the CSI, wherein the information comprises at least a processing criterion or a computation time; and
performing a subsequent communication with the terminal device based on the CSI report.

3. The method of claim 1, wherein the CSI report comprises a parameter indicating a location of a strongest coefficient for each layer of a precoder.

4. The method of claim 3, wherein
the parameter occupies X bits, wherein X is associated with a value K^{NZ} that represents a number of non-zero coefficients in the precoder; or
non-zero coefficients are indicated based on parameter that indicates a distance between the non-zero coefficients and the strongest coefficient.

5. The method of claim 4, wherein
the CSI report identifies a precoder that is associated with a first type of vectors, a second type of vectors, and a third type of vectors, wherein X is equal to ceil (log (2, min (K^{NZ}, 2L))) or ceil (log (2, min (K^{NZ}, 2LQ))), wherein L represents a number of the first type of vectors in the precoder and Q represents a number of the third type of vectors in the precoder; or
the CSI report identifies a precoder that is associated with a first type of vectors, a second type of vectors, and a third type of vectors, wherein the parameter occupies Y bits, wherein Y is associated with a value L that represents a number of the first type of vectors in the precoder.

6. (canceled)

7. The method of claim 5, wherein Y is equal to ceil (log (2, 2L)) or ceil (log (2, 2LQ)), wherein L represents a number of the first type of vectors in the precoder and Q represents a number of the third type of vectors in the precoder.

8. The method of claim 5, wherein the CSI report is associated with a CSI reference signal resource set that includes N resources, and wherein L is determined as
$$L = {\sum }_{n = 0}^{N - 1} {L}_{n} ,$$
Ln representing a number of the first type of vectors associated with an n-th resource in the reference signal resource set.

9. (canceled)

10. The method of claim 4, wherein the parameter is configured by the base station, and wherein a value of the parameter is determined based on a number of a second type of vectors in the precoder.

11. The method of claim 1, wherein the CSI report identifies a precoder that is associated with a first type of vectors, a second type of vectors, and a third type of vectors, and wherein, for each reported element in the CSI report, a priority is associated with the reported element based on an index of a vector of the third type.

12. The method of claim 11, wherein
the priority is based on a number of the third type of vectors; or
the priority is based on a number of the second type of vectors; or
the priority is determined based on 2·L·ν·Q·F(f)+2·L·ν·G(q)+ν·i+l, wherein L represents a number of the first type of vectors, ν represents a number of ranks in the precoder, Q represents a number of the third type of vectors, f represents an index of a second type vector, F(f) represents a function with respect to f, q represents an index of a third type vector, and G(q) represents a function with respect to q; or
the priority is determined based on 2·L·ν·M·G(q)+2·L·ν·F(f)+ν·i+l, wherein L represents a number of the first type of vectors, ν represents a number of ranks in the precoder, M represents a number of the second type of vectors, q represents an index of a third type vector, G(q) represents a function with respect to q, f represents an index of a second type vector, F(f) represents a function with respect to f.

13.-15. (canceled)

16. The method of claim 1, wherein the processing criterion is based on a number of CSI processing units used to determine the CSI report, and wherein the number of CSI processing units is based on a constant that is greater than or equal to 1 or a capability of the terminal device.

17. The method of claim 16, wherein
the number of CSI processing units is based on a periodic of a CSI reference signal resource; or
the CSI report identifies a precoder that is associated with a first type of vectors, a second type of vectors, and a third type of vectors, and wherein the number of CSI processing units is based on a length of a vector of the third type; or
the number of CSI processing units used to determine the CSI report is based on one or more resources for the one or more reference signals.

18.-19. (canceled)

20. The method of claim 17, wherein
the number of CSI processing units is based on a number of CSI reference signal (RS) resources; or
the number of CSI processing units is based on an offset between two CSI RS resources.

21. The method of claim 20, wherein the number of CSI reference signal (RS) resources are configured into one resource set.

22. (canceled)

23. The method of claim 1, wherein the computation time is based on at least a first computation delay or a second computation delay, the method further comprising:
adapting at least one of the first computation delay or the second computation delay for transmitting the CSI report such that at least one of the first computation delay or the second computation delay comprises additional symbols.

24. The method of claim 23, wherein
the first computation delay and/or the second computation delay are based on a constant or a capability of the terminal device; or
the first computation delay and/or the second computation delay are based on a periodicity of CSI RS resource; or
the CSI report identifies a precoder that is associated with a first type of vectors, a second type of vectors, and a third type of vectors, and wherein the first computation delay and/or the second computation delay are based on a length of a vector of the third type; or
the first computation delay and/or the second computation delay are based on an offset between two CSI RS resources; or
the first computation delay and/or the second computation delay are based on a number of CSI RS resources; and
wherein the number of CSI RS resources are configured into one resource set.

25.-29. (canceled)

30. The method of claim 1, wherein a number of CSI processing units and at least one of a first computation delay or a second computation delay are determined based on a signaling message from the base station.

31. The method of claim 30, wherein the signaling message comprises a Radio Resource Control message.

32. A communication apparatus, comprising a processor configured to implement operations of:
transmitting, by a base station to a terminal device associated with a mobility event, one or more reference signals;
receiving, by the base station, a channel state information (CSI) report that is determined based on the one or more reference signals and information related to the CSI, wherein the information comprises at least a processing criterion or a computation time; and
performing a subsequent communication with the terminal device based on the CSI report.

33. A computer program product having code stored thereon, the code, when executed by a processor, causing the processor to implement a method recited in claim 1.
